(19) United States
(12) Patent Application Publication
(10) Pub. No.: US 2006/0179317 A1
(43) Pub. Date: Aug. 10, 2006

(54) E-mail terminal device

(75) Inventors: Kazuo Soumiya, Kyoto-shi (JP); Yoshifumi Tanimoto, Hirakata-shi (JP); Shigeki Takeuchi, Otsu-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MURATA KIKAI KABUSHIKI KAISHA, Kyoto-shi (JP)

(21) Appl. No.: 11/297,428

(22) Filed: Dec. 9, 2005

(30) Foreign Application Priority Data
Feb. 8, 2005 (JP) 2005-031183

(51) Int. Cl. H04L 9/00

(52) U.S. Cl. 713/176

(57) ABSTRACT

An e-mail terminal device capable of carrying out a printing process, a storing process or the like of only e-mail with a signature or only e-mail with a signature of a trustable Certificate Authority (CA). When receiving e-mail, a determination is made as to whether or not the e-mail requires a signature. When the e-mail requires a signature, a determination is made as to a presence or an absence of the signature, whether or not a verification result of the signature is proper, and whether or not a CA issuing a public key used for the verification of the signature is trustable. When a signature is not attached, when the signature is improper, or when the CA is untrustable, the printing process is not executed. E-mail requesting retransmission of e-mail with a signature or e-mail signed by a secret key of a trustable CA is transmitted to a transmitter.

### BACKGROUND OF THE INVENTION

1. Field of the Invention

The present invention relates to an e-mail terminal device. In particular, the present invention relates to an e-mail terminal device capable of receiving electronic mail (hereinafter “e-mail”) with an electronic signature.

2. Description of the Related Art

When a transmitter transmits e-mail by using a computer system, the e-mail is stored in an e-mail server managing an address of a destination. A communication terminal at a receiving end retrieves e-mail and confirms the content of the e-mail. When the e-mail is unnecessary, the e-mail is discarded.

A recent digital Multi Function Peripheral (MFP) includes a conventional copy function and a conventional facsimile function. In addition, the digital MFP includes a function for transmitting image information transmitted from a Personal Computer (PC) or the like, connected to the digital MFP via a communication network, to another facsimile machine. The digital MFP also includes a printer function for printing out the image information, and an e-mail function for transmitting and receiving the e-mail.

Such e-mail is an essential business communication tool for reasons of convenience and promptness of the e-mail. However, since the e-mail may be wiretapped, rewritten, falsified or spoofed, the e-mail is encrypted and transmitted or received. A generally known cipher system includes a common key cipher system and a public key cipher system. According to the common key cipher system, the same key is used for encryption and decryption of a message. According to the public key cipher system, different keys are used for encryption and decryption of a message (a public key is used for the encryption and a secret key is used for the decryption).

The public key is a cipher key which a relationship with a user, who is an owner of the public key, has been certified officially by a Certificate Authority (CA) and which has been disclosed to the general public. The secret key is a cipher key as a counterpart of the public key. E-mail encrypted by the public key can only be decrypted by the secret key. E-mail encrypted by the secret key can only be decrypted by the public key. Therefore, a digital signature of the e-mail, which has been encrypted (signed) by using the public key, can be verified by using the secret key.

A certificate issued by the CA is data which certifies that the public key is authentic. By using the public key authenticated by the certificate, a digital signature signed by using the secret key, which is a counterpart of the public key, can be verified. Accordingly, a presence or an absence of a falsification of data can be detected.

As described above, the conventional e-mail terminal device can receive e-mail with a signature. However, a digital MFP prints out a main body of the received e-mail regardless of a presence or an absence of the signature. Therefore, a distinction cannot be made as to whether or not a signature was attached. Thus, there exists a drawback that a confirmation cannot be made as to whether or not a signature was attached to the e-mail that should have been attached with a signature.

In case of e-mail with a signature, a presence or an absence of the signature can be printed out. However, there exists a large number of CAs, and there exists some CAₛ which cannot be trusted. A determination that the e-mail is trustable cannot be made just by the presence or the absence of the signature. From the printed out paper, a confirmation cannot be made as to whether or not the signature is based on a certificate of a trustable CA. Furthermore, in case of storing e-mail into a mailbox of each user in an e-mail server or the like, even when the signature is verified and the e-mail is stored in the mailbox of each user, it is difficult for the user to confirm whether or not the signature was a signature of a trustable CA.

### SUMMARY OF THE INVENTION

In order to overcome the problems described above, an advantage of the present invention is to provide an e-mail terminal device capable of executing a printing process, a storing process or the like of only e-mail with a signature or only e-mail with a signature of a trustable CA.

According to an aspect of the present invention, an e-mail terminal device includes an e-mail receiving unit, a signature verification unit, a printer unit and a control unit. The control unit controls each of the e-mail receiving unit, the signature verification unit and the printer unit. The e-mail terminal device can receive e-mail with a signature. When receiving e-mail, the control unit determines whether or not a signature is attached to the e-mail. The printer unit prints out only the e-mail with the signature.

According to another aspect of the present invention, an e-mail terminal device includes an e-mail receiving unit, a signature verification unit, an e-mail storage unit and a control unit. The control unit controls each of the e-mail receiving unit, the signature verification unit and the e-mail storage unit. The e-mail terminal device can receive e-mail with a signature. When receiving e-mail, the control unit determines whether or not a signature is attached to the e-mail. The e-mail storage unit stores only the e-mail with the signature.

According to another aspect of the present invention, the control unit verifies the signature in accordance with information of a certificate, and determines whether or not a CA of the certificate can be trusted. Only when the signature is a proper signature trusted by the CA, the e-mail is printed out or stored. The e-mail terminal device also includes a storage unit which stores a condition of e-mail requiring the signature. The control unit determines whether or not the e-mail requires a signature in accordance with the condition stored in the storage unit. The control unit determines a presence or an absence of a signature only for the e-mail requiring the signature.

According to another aspect of the present invention, when a signature is not attached to the received e-mail, or when the signature cannot be trusted by the CA, the control unit requests a transmitter to retransmit e-mail with a signature or e-mail with a signature trusted by the CA.

According to the above-described aspects of the present invention, the e-mail terminal device prints out or stores only e-mail with a signature or only e-mail with a signature trusted by a CA. When the e-mail is printed out or when the e-mail is stored, a user can confirm that a signature has been attached to the e-mail or that a signature trusted by the CA has been attached to the e-mail.

Since the e-mail terminal device includes the storage unit which stores the condition of the e-mail requiring the signature, a determination of a presence or an absence of a signature can be made only for the e-mail requiring the signature. When the signature is not attached to the e-mail or when the signature cannot be trusted by the CA, the e-mail terminal device requests retransmission of the e-mail. Therefore, a transmitter can recognize that the e-mail is necessary to be transmitted again.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 illustrates an example of a network configuration of a system including a digital MFP.

FIG. 2 is a block diagram illustrating a hardware configuration of the digital MFP.

FIG. 3 is a functional block diagram illustrating functions of an e-mail processing unit.

FIG. 4 illustrates an example of a table stored in a certificate information management unit.

FIG. 5 illustrates an example of a table stored in a receiving destination list storage unit.

FIG. 6 illustrates an example of a list of trusted certificate authority.

FIG. 7 illustrates an example of a condition table of a signature required list.

FIG. 8 is a flowchart illustrating an operation carried out when transmitting e-mail.

FIG. 9 is a flowchart illustrating an operation carried out when receiving e-mail.

FIG. 10 is a flowchart illustrating an operation carried out when storing received e-mail in a mailbox.

FIG. 11 illustrates an example of a condition table for specifying a user of a receiving destination.

### DETAILED DESCRIPTION OF PREFERRED EMBODIMENTS

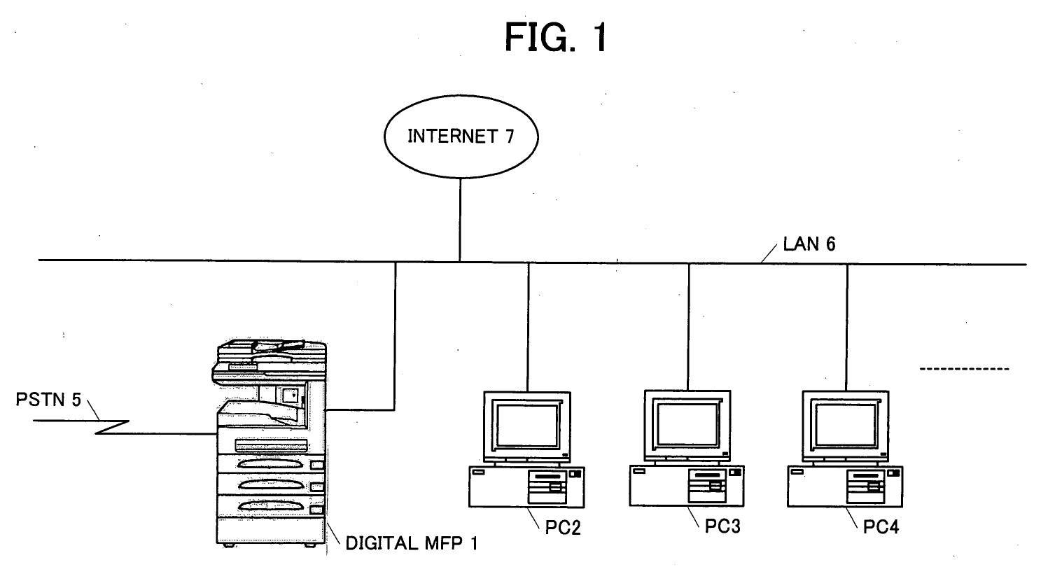

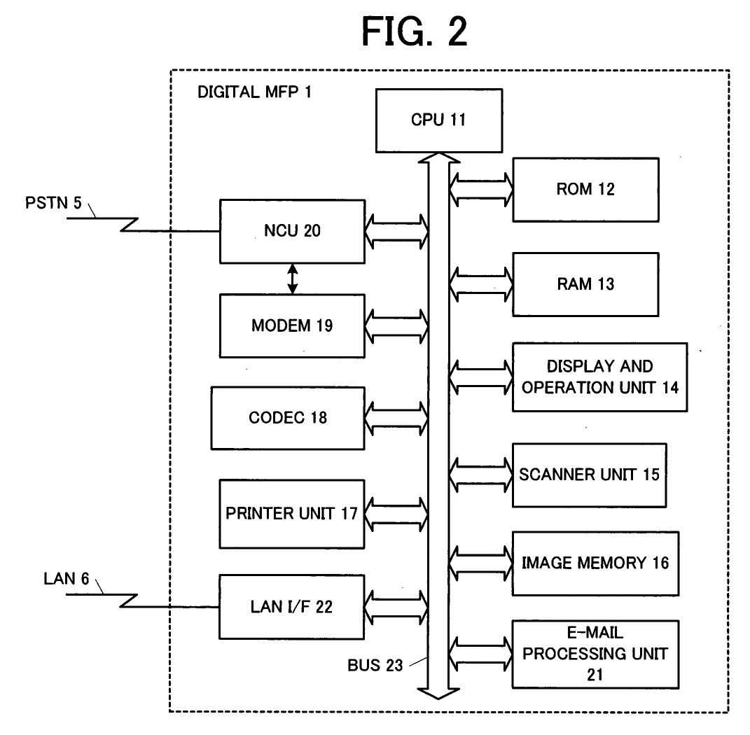

With reference to the drawings, a description will be made of an e-mail terminal device according to a preferred embodiment of the present invention. FIG. 1 illustrates an example of a network configuration of a system including a digital MFP as the e-mail terminal device according to a preferred embodiment of the present invention. FIG. 2 is a block diagram illustrating a hardware configuration of the digital MFP.

In FIG. 1 illustrating a network configuration, reference numeral 1 denotes a digital MFP, reference numerals 2, 3, 4 and so forth respectively denote a PC of a user, reference numeral 5 denotes a Public Switched Telephone Network (PSTN), 6 denotes a Local Area Network (LAN) and 7 denotes the Internet. The digital MFP 1 includes each function of a copy mode, a printer mode and a fax mode. The digital MFP 1 also includes an e-mail transmitting and receiving function. The digital MFP 1 is connected to the PSTN 5 and the LAN 6. A plurality of PCs 2, 3, 4 and so forth as terminal devices are connected to the LAN 6. The LAN 6 is also connected to the Internet 7. The digital MFP 1 can transmit and receive e-mail via the Internet 7.

FIG. 2 is a schematic block diagram illustrating a configuration of a control system of the digital MFP 1. As illustrated in FIG. 2, the digital MFP 1 includes a Central Processing Unit (CPU) 11, a Read Only Memory (ROM) 12, a Random Access Memory (RAM) 13, a display and operation unit 14, a scanner unit 15, an image memory 16, a printer unit 17, a Coder-Decoder (CODEC) 18, a Modulator-Demodulator (MODEM) 19, a Network Control Unit (NCU) 20, an e-mail processing unit 21 and a LAN InterFace (LAN I/F) 22. Each of the units of the digital MFP 1 is connected via a bus 23.

The CPU 11 controls each of the units of the digital MFP 1 via the bus 23. The CPU 11 executes various programs in accordance with a program stored in the ROM 12. The ROM 12 previously stores various programs and an operation message or the like necessary for an operation of the digital MFP 1. The RAM 13 includes a Static Random Access Memory (SRAM) or the like. The RAM 13 stores temporary data that generates when a program is executed.

The display and operation unit 14 displays an operational state of the digital MFP 1. The display and operation unit 14 includes a display unit for displaying an operation screen of various functions, and a plurality of keys for operating the digital MFP 1. The scanner unit 15 includes a document placing table for a scanning operation. For example, the scanner unit 15 includes an Automatic Document Feeder (ADF) and a Flat Bed Scanner (FBS). The scanner unit 15 scans an original document by a scanner using a Charge-Coupled Device (CCD) or the like. Then, the scanner unit 15 outputs dot image data.

The image memory 16 includes a Dynamic Random Access Memory (DRAM) or the like. The image memory 16 stores transmission image data, received image data, or image data scanned by the scanner unit 15. The printer unit 17 includes an electrophotographic printer device. The printer unit 17 prints out received data, data of an original document, or print data transmitted from a remote PC.

The CODEC 18 encodes and decodes image data according to a prescribed protocol. For transmitting image data of the scanned original document, the CODEC 18 encodes the image data by the Modified Huffman (MH), the Modified Relative Address Designate (MR) or the Modified Modified READ (MMR) method. The CODEC 18 decodes image data received from a remote device. The CODEC 18 also encodes and decodes image data according to the Tagged Image File Format (TIFF), which is a generally used image format, as a file attachable to e-mail.

The MODEM 19 is connected to the bus 23. The MODEM 19 includes a function as a faxmodem capable of carrying out facsimile communication. The MODEM 19 is also connected to the NCU 20, which is connected to the bus 23 in the same manner. The NCU 20 is hardware which carries out an operation for breaking and making an analog telephone line. According to necessity, the NCU 20 connects the MODEM 19 to the PSTN 5.

The LAN I/F 22 is connected to the LAN 6. The LAN I/F 22 receives via the LAN 6, data from a remote PC or a signal from the Internet 7. The LAN I/F 22 transmits a signal or data to the LAN 6. The LAN I/F 22 executes an interface processing such as a signal conversion and a protocol conversion.

The digital MFP 1 includes the above-described configuration. When carrying out facsimile transmission, image data of an original document is scanned by the scanner unit 15, compressed by the CODEC 18, and stored into the image memory 16. The compressed image data is retrieved from the image memory 16, modulated by the MODEM 19, and transmitted to a destination from the NCU 20 through the PSTN 5. When carrying out facsimile reception, the received image data is demodulated by the MODEM 19 and stored into the image memory 16. Then, the image data is decrypted by the CODEC 18 and printed out by the printer unit 17.

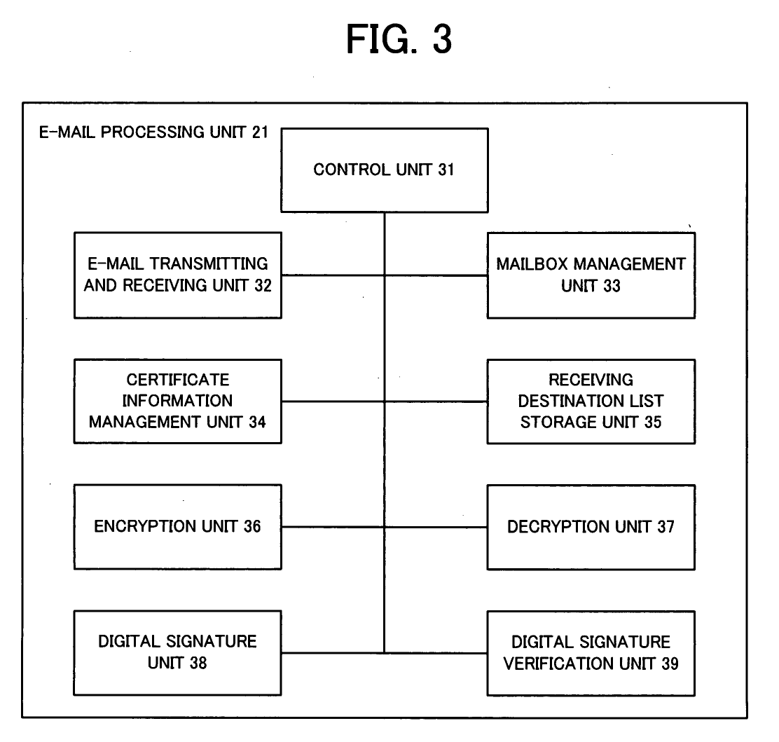

FIG. 3 is a functional block diagram illustrating functions of the e-mail processing unit 21. The e-mail processing unit 21 includes a control unit 31, an e-mail transmitting and receiving unit 32, a mailbox management unit 33, a certificate information management unit 34, a receiving destination list storage unit 35, an encryption unit 36, a decryption unit 37, a digital signature unit 38 and a digital signature verification unit 39. Each of the units 31 through 39 includes a CPU, a ROM and a RAM. A function of each of the units 31 through 39 is executed by a software program. Further, the CPU 11, the ROM 12 and the RAM 13 can be used as the CPU, the ROM and the RAM of the e-mail processing unit 21.

The control unit 31 controls the entire e-mail processing unit 21. The e-mail transmitting and receiving unit 32 receives e-mail transmitted by a remote e-mail server or a facsimile server. The e-mail transmitting and receiving unit 32 transmits e-mail received from the client PCs 2, 3 and 4 or the like to a designated transmission destination. The mailbox management unit 33 includes a mailbox set for each user. For example, a transmitted and received e-mail document and an attached file received along with e-mail are stored in a database of the mailbox.

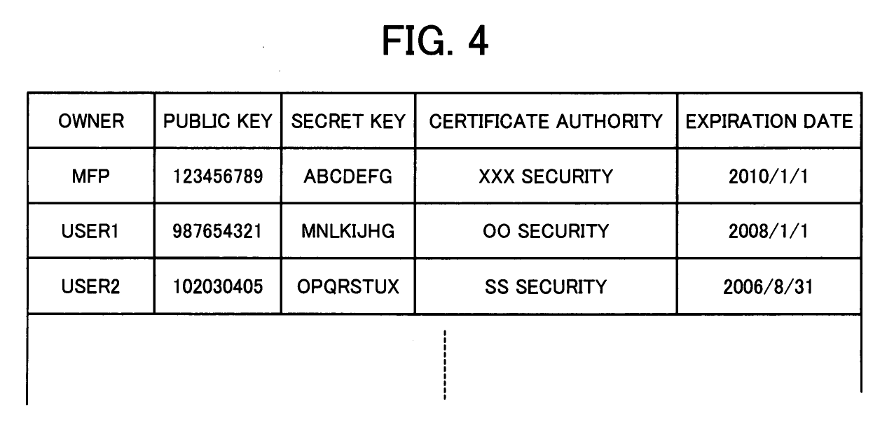

The certificate information management unit 34 stores certificate information obtained from a CA. As illustrated in FIG. 4, the certificate information includes certificate information for each user and certificate information of the digital MFP 1 itself. The certificate information for each user includes a public key, a secret key, a CA and an expiration date or the like. The certificate information management unit 34 stores the certificate information in a form of a table. The certificate information management unit 34 also stores public key information of a transmission destination.

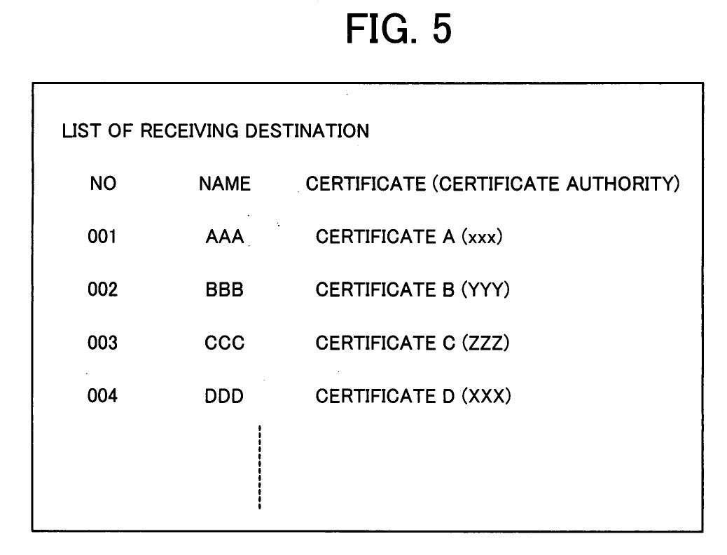

As illustrated in FIG. 5, for example, the receiving destination list storage unit 35 stores a table of a receiving destination list including a public key certificate. The public key certificate includes a name of a receiving destination and a name of a CA. Further, when receiving e-mail, a name of a transmitter of the received e-mail can be stored as information of the public key certificate. Alternatively, a user can input a name of an individual transmitter as the information of the public key certificate. A public key certificate can be obtained by storing a public key certificate transmitted from the transmitter. Alternatively, a public key certificate can be obtained by acquiring a public key certificate having a digital signature for a name, an e-mail address and a public key of an owner signed by a secret key of a CA issued by the CA.

The encryption unit 36 encrypts entire e-mail or only a main body of e-mail by using a public key of a transmission destination. The decryption unit 38 decrypts encrypted e-mail or a main body of encrypted e-mail by using a secret key of a receiving destination. The digital signature unit 38 generates an electronic signature for e-mail by using a secret key of a transmitter. The digital signature verification unit 39 verifies the electronic signature attached to the e-mail by using a public key of the transmitter of the e-mail, and confirms integrity of the e-mail, i.e., confirms that the e-mail has not been falsified. Further, the digital signature verification unit 39 stores a list of trusted CA and a signature required list.

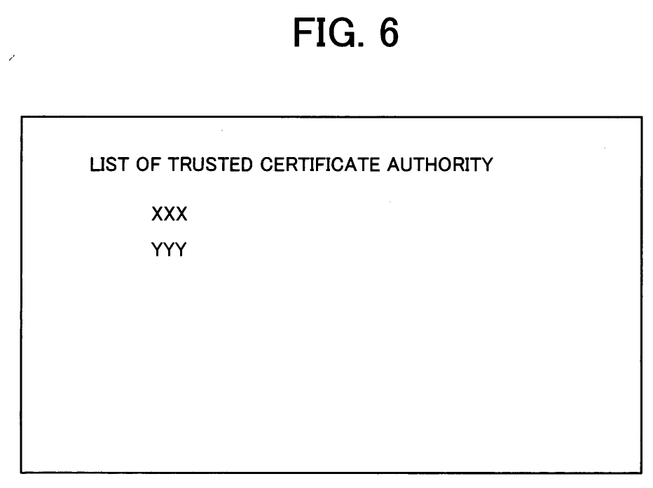

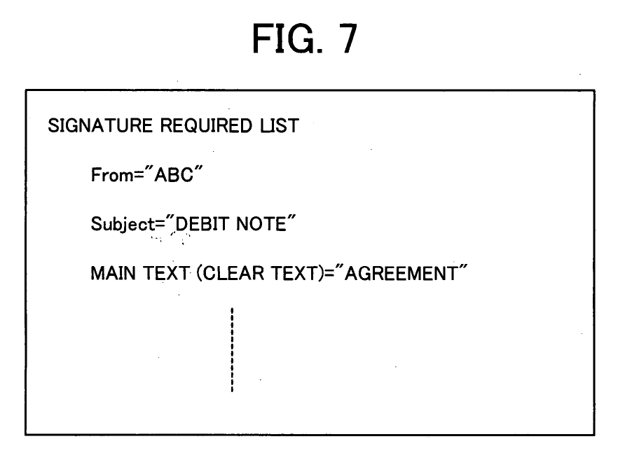

As illustrated in FIG. 6, the list of trustable CA stores a name of a trustable CA, such as “XXX” and “YYY”. A manager or each user of the digital MFP 1 can input the CA from the display and operation unit 14 of the digital MFP 1 or the PCs 2, 3, 4 or the like. As illustrated in FIG. 7, the signature required list is a table which stores a condition for determining whether or not e-mail requires a signature according to words and phrases included in header information or a main body of the e-mail.

That is, the e-mail includes prescribed header information and a main body. The header information includes “Data” indicating a date and time of transmission of the e-mail, “To” indicating a destination of the e-mail, “From” indicating a transmitter of the e-mail, and “Subject” indicating additional information such as a title of the e-mail. When the digital MFP 1 receives the e-mail, an e-mail address exclusive to the digital MFP 1 is written in the “To” field. Thus, a user of the transmission destination cannot be specified.

Therefore, a determination as to whether or not the e-mail requires a signature is made according to a content written in the “From” field, the “Subject” field or the main body. For example, as illustrated in FIG. 7, when “ABC” is written in the “From” field, when the words “debit note” is written in the “Subject” field, or when the word “agreement” is written in the main body, if a signature is not attached to the received e-mail, the e-mail is not printed out nor stored into a mailbox of the user.

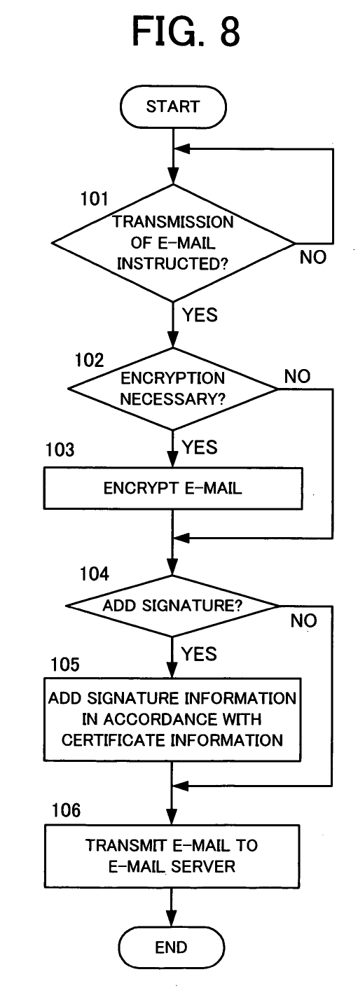

Next, with reference to the flowchart of FIG. 8, a description will be made of an operation of the e-mail processing unit 21 carried out when transmitting e-mail. The control unit 31 of the e-mail processing unit 21 executes an e-mail transmission program of the flowchart illustrated in FIG. 8 at all times. The control unit 31 determines whether or not an e-mail transmission instruction has been input from the PCs 2, 3, 4 or the like (step 101). For example, when the control unit 31 receives an e-mail transmission instruction including an e-mail address of the destination, a main body of the e-mail, necessity or non-necessity of encryption and necessity or non-necessity a signature, the control unit 31 determines whether or not an encryption of the e-mail is instructed (step 102). When a determination is made that the encryption is necessary, the encryption unit 36 encrypts the main body of the e-mail (step 103). That is, the encryption unit 36 encrypts the e-mail by using public key information of the destination registered in the certificate information management unit 34.

After encrypting the e-mail at step 103, or when a determination is made at step 102 that an encryption is not necessary, the control unit 31 determines whether or not to add a signature (step 104). When a determination is made to add a signature, the control unit 31 controls the digital signature unit 38 to generate a digital signature, and adds the generated digital signature to the e-mail (step 105). That is, the digital signature unit 38 generates a message digest from the entire e-mail by using a hush function (one-way digest function). Then, the digital signature unit 38 encrypts the generated message digest by using a secret key of the digital MFP 1 managed by the certificate information management unit 34, and generates a digital signature. After adding the digital signature, or when a determination is made at step 104 not to add a digital signature, the control unit 31 transmits the e-mail to the e-mail address of the destination by the e-mail transmitting and receiving unit 32 (step 106).

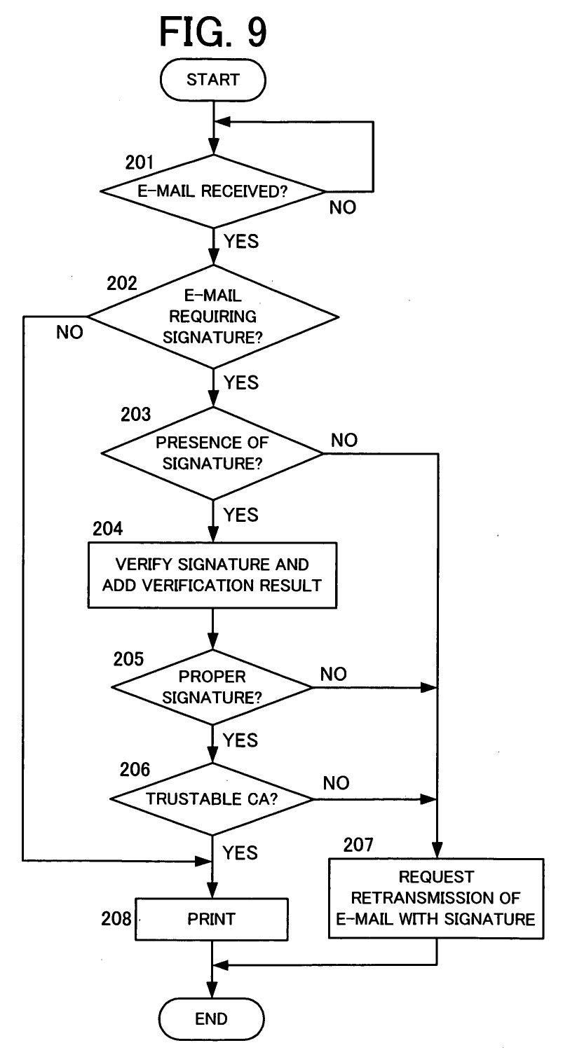

Next, with reference to the flowchart of FIG. 9, a description will be made of an operation of the control unit 31 carried out when receiving e-mail via the Internet 7 or the like. The control unit 31 executes an e-mail receiving program of the flowchart illustrated in FIG. 9 at all times. The control unit 31 determines whether or not the e-mail transmitting and receiving unit 32 has received e-mail (step 201). When receiving the e-mail, the control unit 31 determines whether or not the received e-mail is e-mail requiring a signature in accordance with a signature required condition stored in the digital signature verification unit 39 (step 202). When a determination is made that the e-mail is not e-mail requiring a signature, the control unit 31 executes a printing process of the e-mail (step 208).

Meanwhile, when a determination is made that the received e-mail is e-mail requiring a signature, the control unit 31 determines whether or not a signature is attached (step 203). When a determination is made that a signature is attached, the control unit 31 executes a verification of the signature by the digital signature verification unit 39, and adds a verification result to the e-mail (step 204).

That is, the digital signature verification unit 39 loads the “From” (transmitter) field of the e-mail and specifies the transmitter. Then, the digital signature verification unit 39 decrypts the signature by using a public key of the specified transmitter stored in the certificate information management unit 34, and decodes the message digest. Next, the digital signature verification unit 39 generates a message digest from the entire e-mail by using a hush function that is the same as the hush function of the transmitter. Then, the digital signature verification unit 39 compares the decoded message digest of the transmitter with the message digest of the recipient generated from the e-mail, and determines whether or not the message digests correspond with one another. Accordingly, the digital signature verification unit 39 determines whether or not the e-mail has bee falsified. According to a result of the determination, the control unit 31 adds a result of the verification of the electronic signature and a signature content to the e-mail. For example, the result of the verification is a comment such as “This e-mail is proper e-mail”.

Next, the control unit 31 determines whether or not the signature is a proper signature (step 205). When a determination is made that the signature is a proper signature, the control unit 31 determines whether or not the CA that issued the public key used for the verification of the signature is trustable in accordance with the list of trustable CA stored in the digital signature verification unit 39 (step 206). When a determination is made that the CA is trustable, the control unit 31 prints out the e-mail and the verification result from the printer unit 17 (step 208).

Meanwhile, when a determination is made at step 203 that a signature is not attached, when a determination is made at step 205 that the signature is not proper, or when a determination is made at step 206 that the CA that issued the public key used for the verification of the signature is not trustable, the control unit 31 creates e-mail requesting retransmission of e-mail with a signature or retransmission of e-mail signed by a secret key of a trustable CA. Then, the control unit 31 transmits the e-mail to the transmitter by the e-mail transmitting and receiving unit 32 (step 207).

As described above, a determination is made as to whether or not the received e-mail is e-mail requiring a signature. When a signature is necessary, a printing process is carried out for only the e-mail with the signature or only for the e-mail with the signature trusted by the CA. Therefore, e-mail without a signature or e-mail signed based on a certificate of an untrustable CA can be prevented from being printed out. When the e-mail is not signed or when the signature cannot be trusted by the CA, retransmission of the e-mail is requested. Therefore, a transmitter can confirm that the e-mail is necessary to be transmitted again.

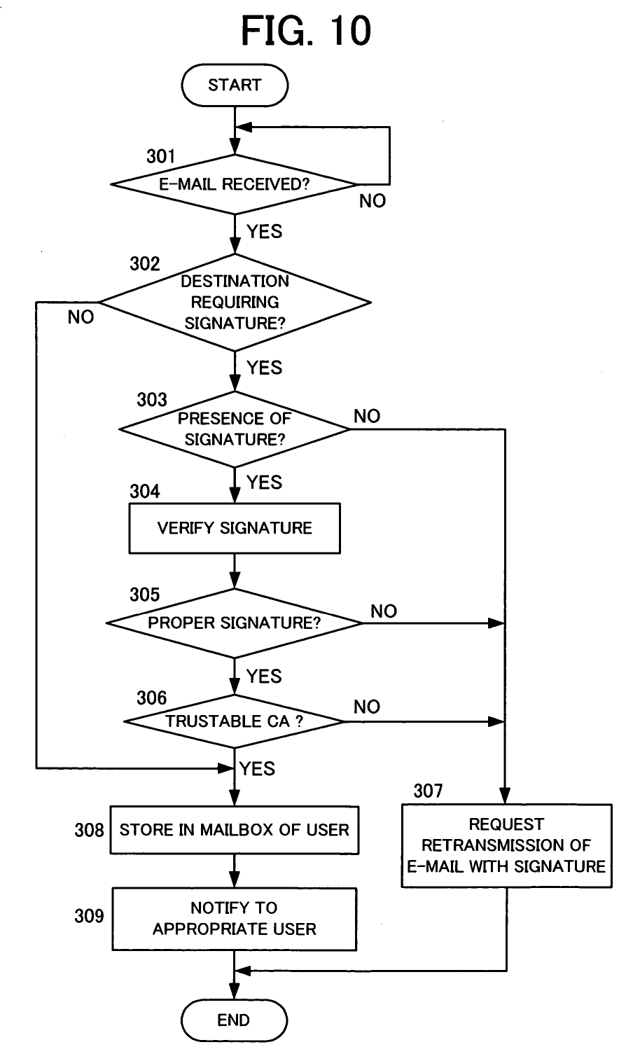

In the above-described preferred embodiment of the present invention, a description has been made of an example in which e-mail is printed out. The present invention can also be applied when storing e-mail into a user box of the mailbox management unit 33. In the following, with reference to the flowchart of FIG. 10, a description will be made of an operation carried out when storing received e-mail into a user box. Further, operations of step 301 through step 307 of the flowchart of FIG. 10 are the same as the operations of step 201 through step 207 of the flowchart of FIG. 9. Therefore, a description of step 301 through step 307 will be omitted.

When a determination is made at step 302 that the received e-mail is e-mail not requiring a signature, or when a determination is made at step 306 that the CA that issued the public key used for the verification of the signature is trustable, the control unit 31 specifies a recipient user from header information or a content of the main body of the received e-mail. Then, the control unit 31 stores the e-mail into a mailbox of the specified recipient user (step 308). Then, the control unit 31 notifies a reception of the e-mail to the recipient user by e-mail or a popup display on a monitor screen (step 309).

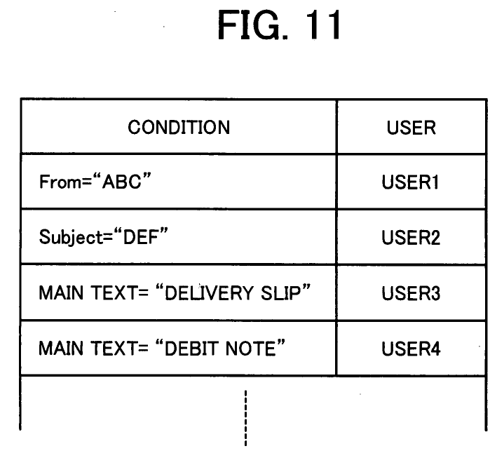

Further, in the same manner as the signature required condition described above, the recipient user can be specified from a content written in the “From” field, the “Subject” field or the main body. A condition for specifying the user of the transmission destination can be stored as a routing table illustrated in FIG. 11. For example, the routing table of FIG. 11 defines that when “ABC” is written in the “From” field, the recipient user is USER1, and when the words “debit note” is written in the main body, the recipient is USER4.

The above-described preferred embodiment has been described with reference to an example in which the e-mail terminal device of the present invention is applied to the digital MFP. However, the e-mail terminal device may be a general e-mail server, a facsimile server or the like. Moreover, the above-described preferred embodiment refers to an example in which the e-mail is transmitted to an e-mail address of the digital MFP. However, the present invention can also be applied to a system in which e-mail is transmitted to an e-mail address set for each user. In case of such a system, a user of a transmission destination may be specified according to an e-mail address, and the e-mail address of each user may be set as a condition for requiring a signature.

While the present invention has been described with respect to preferred embodiments thereof, it will be apparent to those skilled in the art that the disclosed invention may be modified in numerous ways and may assume many embodiments other than those specifically set out and described above. Accordingly, it is intended by the appended claims to cover all modifications of the present invention that fall within the true spirit and scope of the invention.

What is claimed is:

1. An e-mail terminal device, comprising:
means for receiving e-mail;
means for verifying an electronic signature attached to the e-mail by using a public key;
means for printing the e-mail; and
means for controlling, when the means for receiving receives the e-mail, to determine whether or not an electronic signature is attached to the e-mail and to print only the e-mail with the electronic signature by the means for printing.

2. The e-mail terminal device according to claim 1, wherein when the electronic signature is not attached to the e-mail received by the means for receiving, the means for controlling requests a transmitter to retransmit e-mail with an electronic signature.

3. The e-mail terminal device according to claim 1, further comprising means for storing a certificate which certifies a correctness of the public key,
wherein the means for controlling further determines whether or not a certificate authority of the certificate is trustable and prints out only when the certificate authority is trustable.

4. The e-mail terminal device according to claim 3, wherein when the certificate authority of the electronic signature attached to the e-mail received by the means for receiving is untrustable, the means for controlling requests a transmitter to retransmit e-mail with an electronic signature trusted by the certificate authority.

5. The e-mail terminal device according to claim 1, further comprising means for storing a condition of e-mail requiring the electronic signature,
wherein the means for controlling determines whether or not the e-mail is e-mail requiring the electronic signature in accordance with the condition stored in the means for storing and determines a presence or an absence of the signature only for the e-mail requiring the electronic signature.

6. An e-mail terminal device, comprising:
means for receiving e-mail;
means for verifying an electronic signature attached to the e-mail by using a public key;
means for storing the e-mail; and
means for controlling, when the means for receiving receives the e-mail, to determine whether or not an electronic signature is attached to the e-mail and to store only the e-mail with the electronic signature in the means for storing.

7. The e-mail terminal device according to claim 6, wherein when the electronic signature is not attached to the e-mail received by the means for receiving, the means for controlling requests a transmitter to retransmit e-mail with an electronic signature.

8. The e-mail terminal device according to claim 6, further comprising means for storing a certificate which certifies a correctness of the public key,
wherein the means for controlling further determines whether or not a certificate authority of the certificate is trustable and stores the e-mail only when the certificate authority is trustable.

9. The e- mail terminal device according to claim 8, wherein when the certificate authority of the electronic signature attached to the e-mail received by the means for receiving is untrustable, the means for controlling requests a transmitter to retransmit e-mail with an electronic signature trusted by the certificate authority.

10. The e-mail terminal device according to claim 6, further comprising means for storing a condition of e-mail requiring the electronic signature,
wherein the means for controlling determines whether or not the e-mail is e-mail requiring an electronic signature in accordance with the condition stored in the means for storing and determines a presence or an absence of the electronic signature only for the e-mail requiring the electronic signature.
